(19) United States
(12) Patent Application Publication
(10) Pub. No.: US 2026/0162537 A1
(43) Pub. Date: Jun. 11, 2026

(54) EDGE NETWORK-BASED DETERMINATION OF RELEVANT DIRECTIONAL AND TIME-BASED VEHICLE ENCOUNTERS

(71) Applicants: AT&T Intellectual Property I, L.P., Atlanta, GA (US); AT&T Mobility II LLC, Atlanta, GA (US)

(72) Inventors: Stephen Hardin, Suwanee, GA (US); Yupeng Jia, South Pasadena, CA (US); Anthony Dalby, Carrollton, TX (US); James H. Pratt, Round Rock, TX (US)

(73) Assignees: AT&T Intellectual Property I, L.P., Atlanta, GA (US); AT&T Mobility II LLC, Atlanta, GA (US)

(21) Appl. No.: 18/977,177

(22) Filed: Dec. 11, 2024

(51) Int. Cl. G08G 1/16

(52) U.S. Cl. CPC G08G 1/166

(57) ABSTRACT

Aspects of the subject disclosure may include, for example, obtaining first data associated with a first vehicle, wherein the first data comprises a first location, a first direction of travel, and a first velocity; obtaining second data associated with a second vehicle, wherein the second data comprises a second location, a second direction of travel, and a second velocity; identifying an alerting condition caused by the second vehicle; responsive to the identifying of the alerting condition, determining a relative location vector between the first vehicle and the second vehicle; and transmitting a message to the first vehicle, wherein the message includes a description of the alerting condition and the relative location vector. Other embodiments are disclosed.

### FIELD OF THE DISCLOSURE

The subject disclosure relates to edge network-based determination of relevant directional and time-based vehicle encounters.

### BACKGROUND

Certain drivers (such as drivers who are distracted, inattentive, operating under the influence of alcohol, and/or operating under the influence of drugs) can pose hazards to other people on the road.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communication network in accordance with various aspects described herein.

FIG. 2A is a block diagram illustrating an example, non-limiting embodiment of a system (which can function within the communication network of FIG. 1) in accordance with various aspects described herein.

FIG. 2B is a block diagram illustrating an example, non-limiting embodiment of a system (which can function within the communication network of FIG. 1) in accordance with various aspects described herein.

FIG. 2C is a block diagram illustrating an example, non-limiting embodiment of a system (which can function within the communication network of FIG. 1) in accordance with various aspects described herein.

FIG. 2D is a block diagram illustrating an example, non-limiting embodiment of a car speaker alert usage in accordance with various aspects described herein.

FIG. 2E is a block diagram illustrating an example, non-limiting embodiment of a car speaker alert usage in accordance with various aspects described herein.

FIG. 2F depicts an illustrative embodiment of a method in accordance with various aspects described herein.

FIG. 2G depicts an illustrative embodiment of a method in accordance with various aspects described herein.

FIG. 2H depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for enabling a customized alert to be presented to each driver who is within a proximate area of another subject vehicle that may pose a danger. In operation, edge network-based video analysis can be used to identify such a subject vehicle that may pose the danger (after identification, the subject vehicle can be virtually tagged and followed along a path). Further, other vehicle(s) within a zone area around the subject vehicle can be identified (wherein relative location data with respect to the subject vehicle is determined). Moreover, this relative location data can be sent over a network to create the customized alerts for each endangered vehicle. Each customized alert (for a given driver who is being alerted) allows for the specification of a specific direction, relative speed, and expected encounter time with the subject vehicle. Edge nodes and 5G+ capabilities can be utilized to enable the high speed, low latency, and precise location information needed to provide such alerting functions. In various examples, the vehicles can comprise cars, vans, SUVs, trucks, buses, passenger vehicles, commercial vehicles, or any combination thereof. Other embodiments are described in the subject disclosure.

One or more aspects of the subject disclosure include determination in an edge network of relative location vector data between vehicles to predict directional and time-specific vehicle encounters.

One or more aspects of the subject disclosure include a method comprising: obtaining, by a processing system including a processor, first data associated with a first vehicle, wherein the first data comprises a first location, a first direction of travel, and a first velocity; obtaining, by the processing system, second data associated with a second vehicle, wherein the second data comprises a second location, a second direction of travel, and a second velocity; identifying, by the processing system, an alerting condition caused by the second vehicle; responsive to the identifying of the alerting condition, determining, by the processing system, a relative location vector between the first vehicle and the second vehicle; and transmitting, by the processing system, a message to the first vehicle, wherein the message includes a description of the alerting condition and the relative location vector.

One or more aspects of the subject disclosure include a device comprising: a processing system including a processor; and a memory that stores executable instructions that, when executed by the processing system, facilitate performance of operations, the operations comprising: determining whether a first vehicle is being driven in an unlawful manner, an erratic manner, or any combination thereof, wherein the determining results in a first determination; responsive to the first determination being that the first vehicle is driven in the unlawful manner, the erratic manner, or any combination thereof, determining whether at least one other vehicle is within a threshold distance of the first vehicle, resulting in a second determination, wherein the at least one other vehicle comprises a second vehicle; responsive to the second determination being that the at least one other vehicle is within the threshold distance of the first vehicle, obtaining vehicle data associated with the second vehicle, wherein the vehicle data comprises a direction of travel and a velocity; and responsive to the second determination being that the at least one other vehicle is within the threshold distance of the first vehicle, transmitting a notification to the second vehicle, wherein the notification comprises a relative location vector between the first vehicle and the second vehicle.

One or more aspects of the subject disclosure include a non-transitory machine-readable medium comprising executable instructions that, when executed by a processing system including a processor, facilitate performance of operations, the operations comprising: obtaining one or more images of a person driving a first vehicle; performing image analysis on the one or more images to estimate a level of attentiveness that the person is applying to the driving of the first vehicle; determining whether the level of attentiveness fails to meet a threshold level of attentiveness, resulting in a first determination; responsive to the first determination being that the level of attentiveness fails to meet the threshold level of attentiveness, analyzing location data to determine whether a second vehicle is within a threshold distance of the first vehicle, resulting in a second determination; responsive to the second determination being that the second vehicle is within the threshold distance of the first vehicle, obtaining vehicle data associated with the second vehicle, wherein the vehicle data comprises a location, a direction of travel, and a velocity; and responsive to the second determination being that the second vehicle is within the threshold distance of the first vehicle, transmitting a notification to the second vehicle, wherein the notification comprises a warning of inattentiveness of the person driving the first vehicle and position data identifying where the first vehicle is relative to the second vehicle.

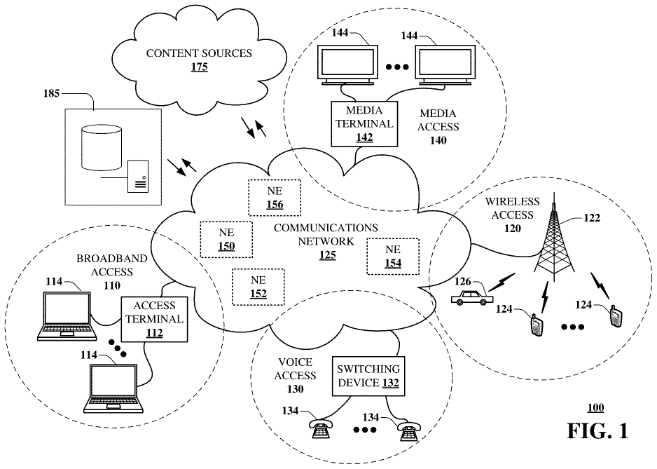

Referring now to FIG. 1, a block diagram is shown illustrating an example, non-limiting embodiment of a system 100 in accordance with various aspects described herein. System 100 can include a vehicle tracking and alerting platform 185 to facilitate tracking of vehicle movement and transmission of notifications associated with such vehicle movement. Platform 185 can include various components and functionality to implement the tracking and alerting, including in a centralized fashion through one or more servers (e.g., located in the network core or elsewhere), in a distributed fashion (e.g., operating in one or more edge servers), in a virtualized fashion (e.g., operating via virtual machines or virtual functions such as in the Cloud), and/or in a combination of these fashions.

For example, platform 185 can facilitate in whole or in part obtaining, by a processing system including a processor, first data associated with a first vehicle, wherein the first data comprises a first location, a first direction of travel, and a first velocity; obtaining, by the processing system, second data associated with a second vehicle, wherein the second data comprises a second location, a second direction of travel, and a second velocity; identifying, by the processing system, an alerting condition caused by the second vehicle; responsive to the identifying of the alerting condition, determining, by the processing system, a relative location vector between the first vehicle and the second vehicle; and transmitting, by the processing system, a message to the first vehicle, wherein the message includes a description of the alerting condition and the relative location vector.

In one or more of the examples described herein, users are frequently described as first, second, third, etc., which should be understood as distinguishing between users in the particular example but is not intended to be limiting in any other way unless expressly described as such.

In one or more embodiments, platform 185 can store user data collected from sensors. In one or more embodiments, the user data can include one or more image files, one or more video files, and/or one or more audio files. In one or more embodiments, each sensor can be part of a respective user device. In one or more embodiments, a sensor can be part of a device that is distinct from any user device.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

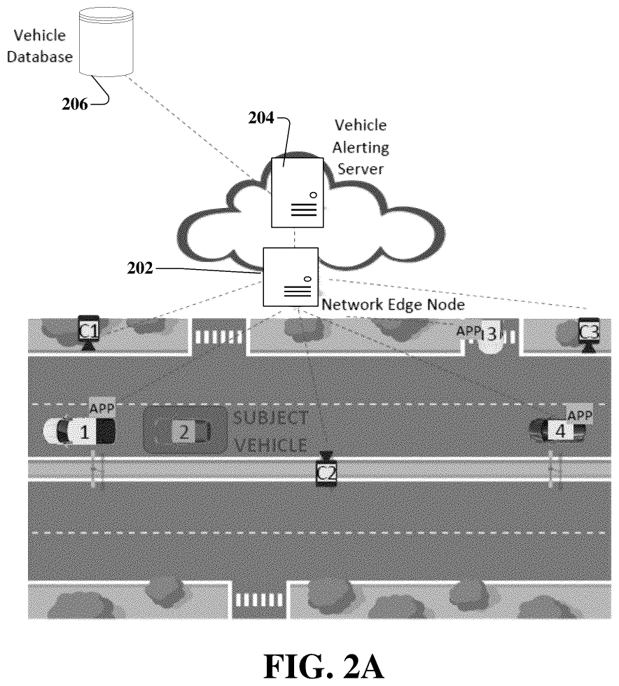

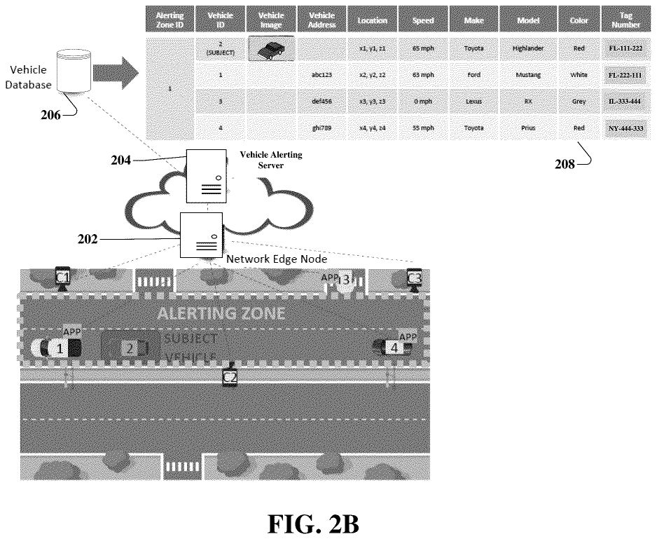

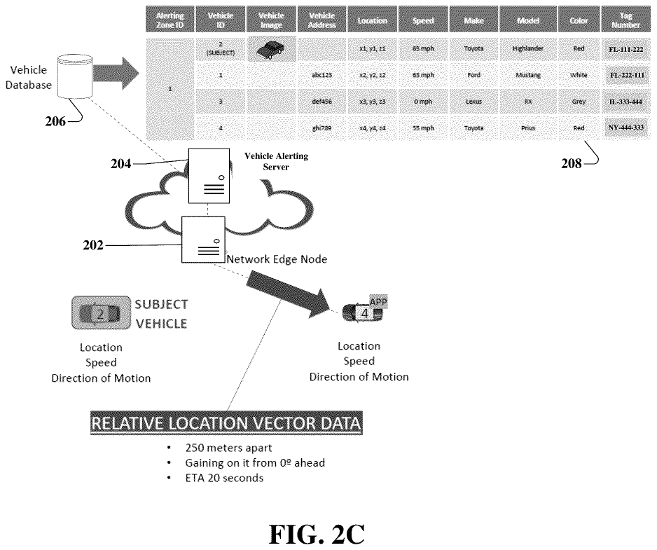

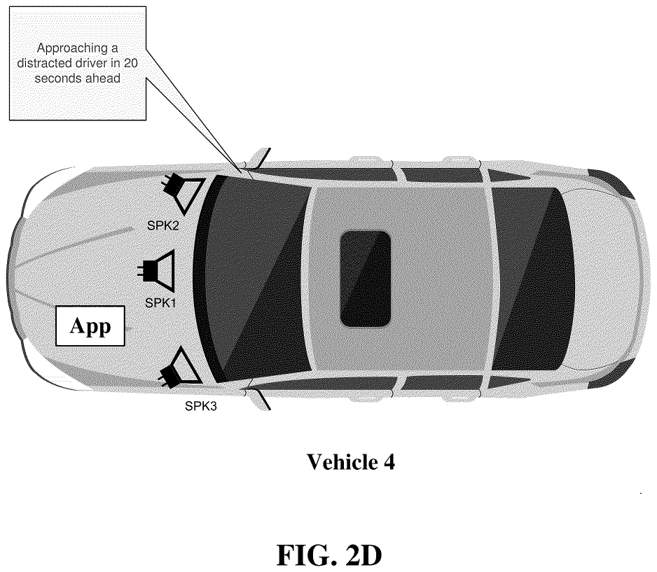

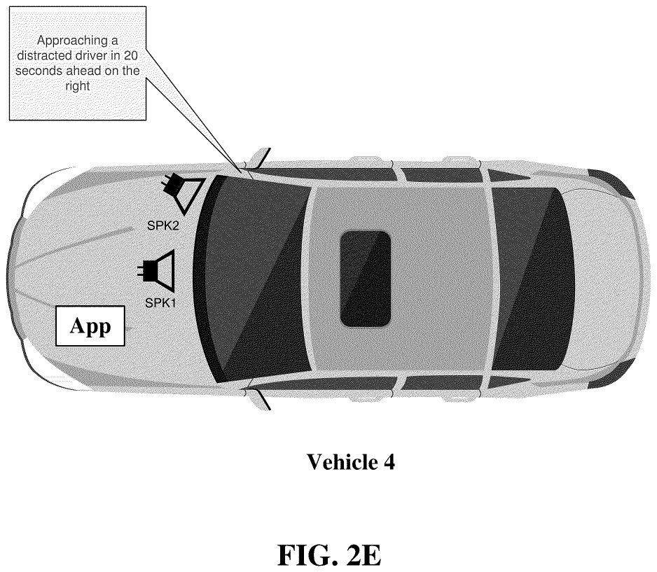

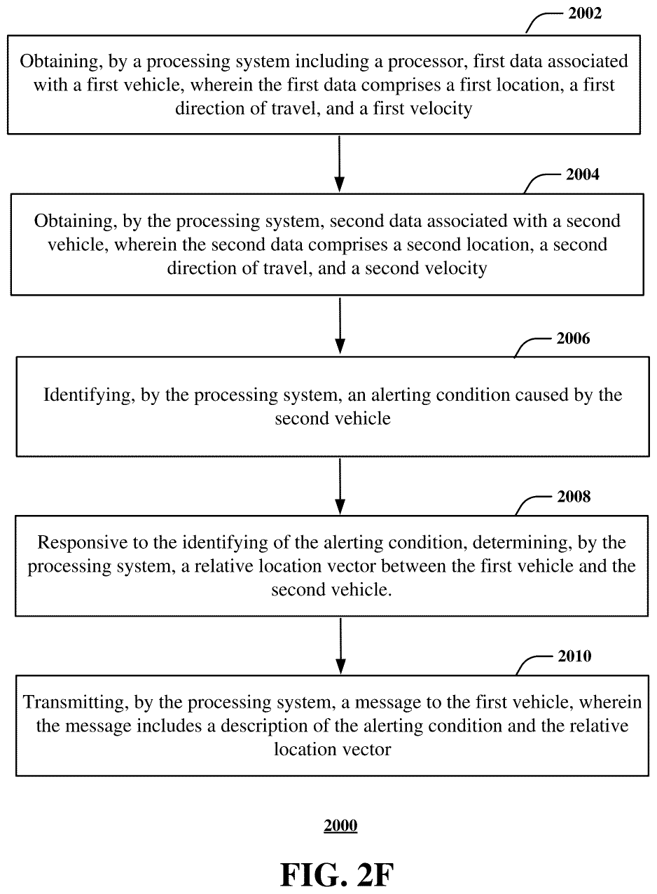

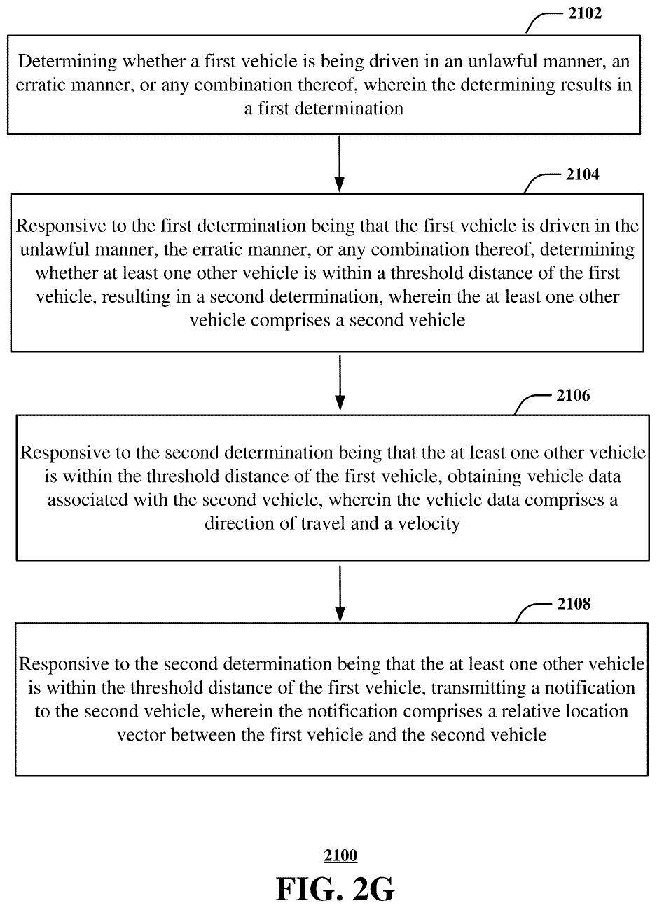

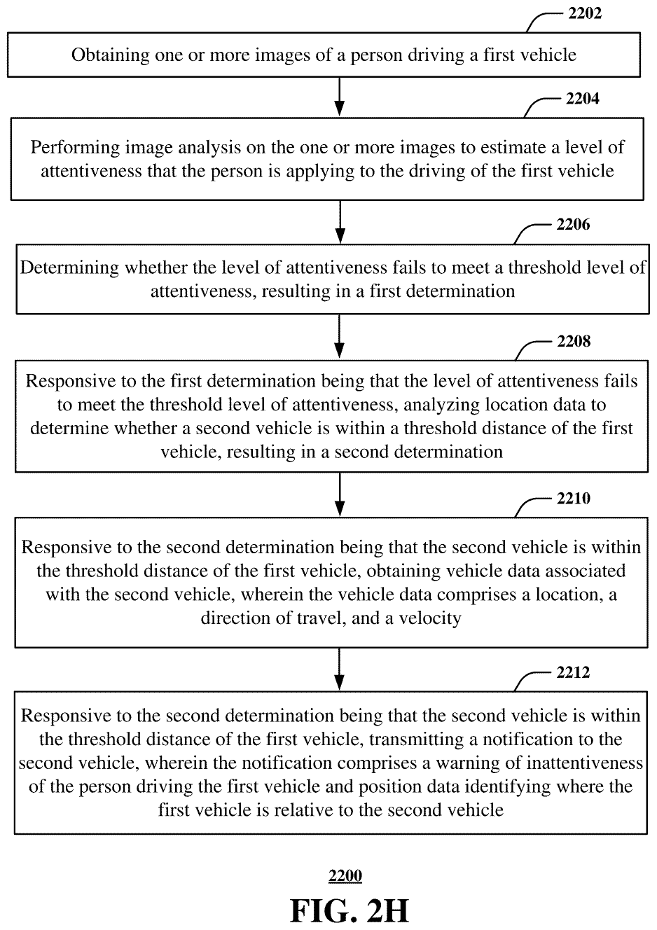

Referring now to FIG. 2A, this is a block diagram illustrating an example, non-limiting embodiment of a system (which can function within the communication network of FIG. 1) in accordance with various aspects described herein. As seen in this figure, a number of cameras (three in this example—C1, C2, C3) are configured for bi-directional communication with a network edge node 202. The network edge node 202 is also configured for bi-directional communication with a vehicle alerting server 204, which in turn has access to a vehicle database 206 (the vehicle database 206 can be co-located with the vehicle alerting server 204 and/or accessed over a network). The cameras C1, C2, C3 can be positioned along a roadway so as to be able to view passing traffic from various angles. A number of vehicles (three in this example) are each equipped with networking capabilities (see vehicle number “1”, vehicle number “3”, and vehicle number “4). Each of vehicle number “1”, vehicle number “3”, and vehicle number “4 is also equipped with a respective vehicle alerting app. Each of the vehicle alerting apps is configured for bi-directional communication with the vehicle alerting server 204 (e.g., via network edge node 202). Each vehicle alerting app can be, for example, an onboard app that is stand-alone or integrated into an infotainment system or the like). In various examples, the network (via which each vehicle alerting app communicates with the edge network node 202) can comprise a cellular network, a fourth generation (4G) network, a fifth generation (5G) network, a subsequent generation network, or any combination thereof. In various examples, the edge network node 202 can operate on a cloud computing platform. Of course, while three vehicles/vehicle alerting apps are described (along with a subject vehicle—discussed in more detail below), any desired number of vehicles/vehicle alerting apps can be supported. Further, while one edge network node is described, any desired number of edge network nodes can be supported.

Still referring to FIG. 2A, a description will now be made regarding detection of an alerting condition according to an embodiment. More particularly, in this embodiment, such detection of an alerting condition can be as follows. Video collected by the cameras can be used to detect the existence of an alerting condition caused by a vehicle. The alerting condition can be determined from the video analysis to be based on a number of conditions created by a subject vehicle, including speeding, erratic path of travel, and/or erratic changes in speed. In one embodiment, video streams can be collected from various cameras in an area and sent to the edge network node 202. The edge network node 202 can use artificial intelligence (AI) techniques and/or other methods to analyze the video streams and detect any conditions that may be out of normal thresholds or otherwise indicate an alerting condition. As an example (which is intended to be illustrative and not restrictive), the video analysis can determine that vehicle 2 is swerving beyond a threshold limit, or is veering off the road a distance beyond an error limit. In other examples, the video analysis can determine that the attentiveness of the driver of the subject vehicle is low. This determination of low attentiveness can be based on, for example: a determination of the direction of line of sight of the driver of the subject vehicle; and/or one or more other factors such as a determination that the driver of the subject vehicle is seen to be distracted in any of a number of ways (for instance, talking to a passenger in the front seat, talking to a passenger in a rear seat, talking on a cellphone, eating, drinking, putting on makeup, yawning, yelling, grimacing, and/or making hand gestures). In other embodiments, an analysis can be performed using conventional artificial intelligence (AI) techniques that have been trained to understand various types of conditions that constitute distracted driving.

Referring now to FIG. 2B, this is a block diagram illustrating an example, non-limiting embodiment of a system (which can function within the communication network of FIG. 1) in accordance with various aspects described herein. In this figure, each of vehicle 1, vehicle 2, vehicle 3, vehicle 4, edge network node 202, vehicle alerting server 204, and vehicle database 206 corresponds to the same element in FIG. 2A. More particularly, this FIG. 2B relates to virtual tagging of a subject vehicle. In operation, upon the identification of a subject vehicle, an alerting zone can be established. In this regard, the network edge node 202 can identify geographic coordinates that correspond to an alerting zone (e.g., based on the current location of the subject vehicle and its orientation and speed). The alerting zone coordinates can be maintained by the network edge node 202, and can change over time as the subject vehicle's location changes over time. In addition, a virtual tag can be applied to the subject vehicle. In one embodiment, this is accomplished by saving an image of the subject vehicle in the vehicle database 206 along with any available identifying information (such as the subject vehicle's make, model, color, and tag number) as collected from the image(s) captured. The current location and speed (as well as the direction of travel) of the subject vehicle can be identified and stored as well (see storage format 208). In one specific example of virtual tagging of a subject vehicle (which example is intended to be illustrative and not restrictive), if camera C3 first identified the alerting condition of vehicle 2 and saved its pertinent information to the vehicle database 206, the network edge node 202 (in communication with the vehicle alerting server 204) can instruct other cameras (such as cameras C2 and C1) to collect subsequent images and data at later times regarding the subject vehicle. This later-captured data from C2 and C1 can then be stored in vehicle database 206 as updated information. Therefore, at any given time, the information in the vehicle database for the subject vehicle can be kept up-to-date with the most recent data collected by the nearest proximate camera to the subject.

Still referring to FIG. 2B, a description will now be made regarding identification of affected vehicles. In operation, the network edge node 202 sends a broadcast message out to the geographic area constituting the alerting zone. In doing so, the broadcast message can contain a set of geographic coordinates that defines the alerting zone such that if the broadcast message is received by a vehicle that is outside of the zone, the vehicle ignores the broadcast message by comparing the geographic coordinates of the alerting zone with its own current location and predicted future location. Vehicles that receive the broadcast message and identify themselves to either be currently within the alerting zone (or predicted to be within the alerting zone within, for example, a threshold amount of time), send a message to the network edge node 202 containing identifying information for the vehicle, so that an entry for the vehicle can be made in the vehicle database 206 as shown (see storage format 208). As with the subject vehicle, the list of vehicles that are affected by the alerting zone can be continuously updated, with other vehicles being added to (or deleted from) the alerting zone as the subject vehicle progresses.

Referring now to FIG. 2C, this is a block diagram illustrating an example, non-limiting embodiment of a system (which can function within the communication network of FIG. 1) in accordance with various aspects described herein. In this figure, each of vehicle 2, vehicle 4, edge network node 202, vehicle alerting server 204, and vehicle database 206 corresponds to the same element in FIG. 2A. More particularly, this FIG. 2C relates to determining relative location vector data. In operation, for each specific vehicle in the alerting zone that is to be alerted, the network edge node 202 can use the vehicle address (e.g., the wireless networking address for communicating with the app in the vehicle) that was provided by the vehicle/app as the destination for the alerting message. The network edge node 202 can also calculate specific relative location vector data for each vehicle that is to be notified with the alert. The network edge node 202 can use the data of the subject vehicle and compare it with the data of the vehicle to which the alert is to be sent. This comparison of data can be used to determine the relative location vector data to be sent with the alerting message. The network edge node 202 can use predictive algorithms to determine certain parameters (such as an estimated time of arrival and direction of approach of the subject vehicle to the vehicle to which the alert is to be sent).

Still referring to FIG. 2C, a description will now be made regarding sending alerting information according to an embodiment. More particularly, in this embodiment, the network edge node 202 can send the content of the alert (for example, that it is regarding a distracted driver), along with the relative location vector data that pertains to vehicle 4 to vehicle 4. The app for vehicle 4 can interpret the received data and create the alert for presentation to the driver of vehicle 4. In one embodiment, the alert can be an audible alert. In one example, the relative location vector data can be used by the app to determine which one or more speakers should be used to present the alert such that only the speakers that are directionally relevant with regard to the relative location of the subject vehicle will be used. In one specific example (which example is intended to be illustrative and not restrictive), only the front speakers are used to present the alert, since the alerting condition (in this example) is occurring ahead of vehicle 4 (see FIG. 2D). In another example, if the relative location vector data indicated that the impending distracted driver had a different relative location to vehicle 4, a different speaker configuration could be used to present the alert. For example (which example is intended to be illustrative and not restrictive), if the alert was ahead on the right, only the center and right front speakers would be used to present the alert (see FIG. 2E). As the relative location vector data changes over time between the two vehicles, the speaker configuration can be adjusted as necessary. For example, after vehicle 4 has passed the subject vehicle, the alert audio could come from the rear speakers only, and indicate, for example, that the encounter had been passed. In another embodiment, the alert can be presented by the app as a visual alert. In one specific example (which example is intended to be illustrative and not restrictive), when the alert concerns a subject vehicle that is ahead of the alerted vehicle, the alert can be presented as a heads up display on the windshield in front of the driver. In another embodiment, the app of the alerted vehicle (e.g., vehicle 4 in this example) can be connected to sensors within the cabin of the alerted vehicle that monitor activity of the driver. These sensors can include sensors that track head movement, eye movement, and/or other attentiveness measures for the driver of the alerted vehicle. As such, the app of the alerted vehicle can have access to information that indicates the current direction of view of the driver of the vehicle. The app of the alerted vehicle can therefore present for display the alert in desired location(s) as heads up display(s) that are within the driver's current field of view. This may be, for example, on a side window, or a rearview mirror, or other available location.

In various embodiments, any of the systems described herein can include hardware and/or software (which can include virtual functionality) for providing data storage functions. As an example, a database can be a single database or multiple databases. A database can operate as a user database storing user information including but not limited to user ID data, user location data, and/or sensor-captured data. A database can operate as a user access database storing other user information (e.g., associated with other users). The various data can be managed and collected through the various techniques described herein, including in real-time, near-teal-time, frequently, according to a schedule, and/or according to polling.

In one or more embodiments, one or more of the sensors can be part of IoT device(s). In one or more embodiments, the sensors can be part of equipment associated with a premises, including a WLAN, a home network, a security network, a building management system, and so forth.

In one or more embodiments, locations of users can be determined. For example, techniques or technologies, such as GPS or Wi-Fi triangulation, can accurately identify the proximity of the users to one another.

In one or more embodiments, thresholds can be maintained and/or adjusted (e.g., user-configured) for distance settings and/or time settings for necessary or desired closeness to be considered. In one or more embodiments, the thresholds can be dynamically adjusted based on various factors.

In one or more embodiments, mechanisms can allow for building up a database of various information.

In one or more embodiments, various sensors and devices can be owned, operated or managed by a user and/or by third-parties, including security cameras, public devices such as traffic cameras, door-bell cameras, and so forth.

In one or more embodiments, a method can be executed in whole or in part utilizing applications resident on end user devices, such as mobile apps on a user's mobile phone. In one or more embodiments, Software Development Kits can be made available to facilitate providing the necessary software on end user devices or other computing devices, including home network equipment.

In one or more embodiments, mechanisms can utilize various IoT devices for collecting data associated with users, such as security cameras for capturing images.

In one or more embodiments, mechanisms can capture various types of data from various sources and synthesize the data.

In one or more embodiments, location detection can be performed in a number of different ways, including monitoring of activity of an end user device of a user (e.g., detecting voice calls being made from the user's mobile phone when the user is located at particular location).

In one or more embodiments, mechanisms can populate or otherwise manage a database utilizing various techniques which can be manually implemented and/or automatically performed. For example, various information associated with the user and other users can be entered by the user and/or other users. Data for users, such as telephone numbers, addresses, etc. can be provided to the database or otherwise retrieved, such as from publicly available information or private sources.

In one or more embodiments, management or maintaining relevant information for the database can be done in a number of different ways which can be automated (e.g., triggered by changes to various subscriber agreements of the user such as where the service provider associated with the subscriber agreement communicates the changes to the database) or manually driven. In one embodiment, a method can monitor communication services (or the initiation thereof) by the user to detect any new or unknown devices, telephone numbers, etc., which can then be provisioned to the database, for example, after being verified by the user as another communication access possibility.

In one or more embodiments, mechanisms can update the user information in the database over time as the user's information changes. In one or more embodiments, mechanisms can apply AI modeling to manage the user information in the database, such as for determining when a particular location of the user is just being visited when travelling or when the particular location is more permanent to the user and requires or otherwise would facilitate operations of the method through collection of physical and/or communication access information or other data.

In one or more embodiments, mechanisms can allow a user to enter initial information associated with themselves and/or with other users (e.g., that are to be considered as part of a group) and, from the initial information (e.g., a friend's name), the mechanisms can further populate the database with known information according to the name or other initial information, such as where the user and the friend subscribe to the same telecommunications service provider. Mechanisms can apply various techniques to implement intelligent provisioning so that the database maintains up-to-date information and is robust. In one or more embodiments, mechanisms can communicate with other systems to collect information for the database, such as public sources (e.g., local tax authority) and/or private sources (e.g., utility company, user's employee, etc.), which can be provided with authorization by the user and/or other users to share certain information that facilitates generation of event recreation.

In one or more embodiments, mechanisms can utilize home networks, security networks, and/or other networks or systems that can have inventories or otherwise have knowledge of devices, sensors and/or other equipment associated with the user or other users (e.g., identity of IoT sensors that communicate with a WLAN of a premises) to populate a database and/or to collect monitoring information (e.g., capturing an image).

In one or more embodiments, mechanisms can utilize, populate and manage a single database that stores user information for all types of users. Although, other embodiments can utilize any number of databases for managing the various user information described herein.

Referring now to FIG. 2F, various steps of a method 2000 according to an embodiment are shown. As seen in this FIG. 2F, step 2002 comprises obtaining, by a processing system including a processor, first data associated with a first vehicle, wherein the first data comprises a first location, a first direction of travel, and a first velocity. Next, step 2004 comprises obtaining, by the processing system, second data associated with a second vehicle, wherein the second data comprises a second location, a second direction of travel, and a second velocity. Next, step 2006 comprises identifying, by the processing system, an alerting condition caused by the second vehicle. Next, step 2008 comprises responsive to the identifying of the alerting condition, determining, by the processing system, a relative location vector between the first vehicle and the second vehicle. Next, step 2010 comprises transmitting, by the processing system, a message to the first vehicle, wherein the message includes a description of the alerting condition and the relative location vector.

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2G, various steps of a method 2100 according to an embodiment are shown. As seen in this FIG. 2G, step 2102 comprises determining whether a first vehicle is being driven in an unlawful manner, an erratic manner, or any combination thereof, wherein the determining results in a first determination. Next, step 2104 comprises responsive to the first determination being that the first vehicle is driven in the unlawful manner, the erratic manner, or any combination thereof, determining whether at least one other vehicle is within a threshold distance of the first vehicle, resulting in a second determination, wherein the at least one other vehicle comprises a second vehicle. Next, step 2106 comprises responsive to the second determination being that the at least one other vehicle is within the threshold distance of the first vehicle, obtaining vehicle data associated with the second vehicle, wherein the vehicle data comprises a direction of travel and a velocity. Next, step 2108 comprises responsive to the second determination being that the at least one other vehicle is within the threshold distance of the first vehicle, transmitting a notification to the second vehicle, wherein the notification comprises a relative location vector between the first vehicle and the second vehicle.

While for purposes of simplicity of explanation, the respective processes are shown and described as a series of blocks in FIG. 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2H, various steps of a method 2200 according to an embodiment are shown. As seen in this FIG. 2H, step 2202 comprises obtaining one or more images of a person driving a first vehicle. Next, step 2204 comprises performing image analysis on the one or more images to estimate a level of attentiveness that the person is applying to the driving of the first vehicle. Next, step 2206 comprises determining whether the level of attentiveness fails to meet a threshold level of attentiveness, resulting in a first determination. Next, step 2208 comprises responsive to the first determination being that the level of attentiveness fails to meet the threshold level of attentiveness, analyzing location data to determine whether a second vehicle is within a threshold distance of the first vehicle, resulting in a second determination. Next, step 2210 comprises responsive to the second determination being that the second vehicle is within the threshold distance of the first vehicle, obtaining vehicle data associated with the second vehicle, wherein the vehicle data comprises a location, a direction of travel, and a velocity. Next, step 2212 comprises responsive to the second determination being that the second vehicle is within the threshold distance of the first vehicle, transmitting a notification to the second vehicle, wherein the notification comprises a warning of inattentiveness of the person driving the first vehicle and position data identifying where the first vehicle is relative to the second vehicle.

While for purposes of simplicity of explanation, the respective processes are shown and described as a series of blocks in FIG. 2H, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, various embodiments provide a method for sending data over a network to a first vehicle describing a location vector of an alerting condition created by a second vehicle relative to the first vehicle, comprising: receiving data describing the alerting condition; receiving data describing the location of the first vehicle; receiving data describing the speed of the first vehicle; receiving data describing the direction of motion of the first vehicle; receiving data describing the location of the second vehicle; receiving data describing the speed of the second vehicle; receiving data describing the direction of motion of the second vehicle; determining data describing a relative location vector between the first vehicle and the second vehicle; and sending the data describing the alerting condition and the data describing the relative location vector to the first vehicle. In one embodiment, the relative location vector comprises the distance between the first vehicle and the second vehicle, the relative speed between the two vehicles, and the relative direction of motion between the two vehicles. In one embodiment, the method further comprises presenting an audible alert to the first vehicle based on the relative location data. In one embodiment, the method further comprises presenting a visual alert to the first vehicle based on the relative location data.

As described herein, various embodiments provide mechanisms to send safety alerts to drivers in such a way that each alert conveys the relative location to the vehicle of a danger in an integrated manner. The relative location data between the danger and the vehicle can be continually updated and can take into account both directionality and distance. In one embodiment, the relative location data can be determined and continually updated by an edge network node and delivered to one or more vehicles within an area such that each vehicle can in turn deliver the respective alert to each driver according to that vehicle's position and current condition.

As described herein, various embodiments can utilize a dedicated app being associated with each alerted vehicle (e.g., wherein each dedicated app communicates with a server to carry out alerting functions).

As described herein, various embodiments can alert a driver of a first vehicle when a second vehicle (which is being driven, for example, by a distracted driver or the like) is approaching the first vehicle (the alert can indicate, for example, that the approach is from the front, from behind, from the driver's side, or from the passenger's side). In various embodiments, the alert can be generated based upon inference of distraction (e.g., image analysis of the second vehicle and/or image analysis of a driver of the second vehicle).

As described herein, various embodiments can track a subject vehicle after the subject vehicle has been identified. In one embodiment, a virtual tag can be assigned to the subject vehicle (the virtual tag can comprise, for example, an image of the subject vehicle that is saved (along with, for example, location, speed, tag (license) number)). In one embodiment, a subject vehicle can be tracked as it moves from the field of view of one sensor (e.g., camera) into the field of view of another sensor (e.g., another camera).

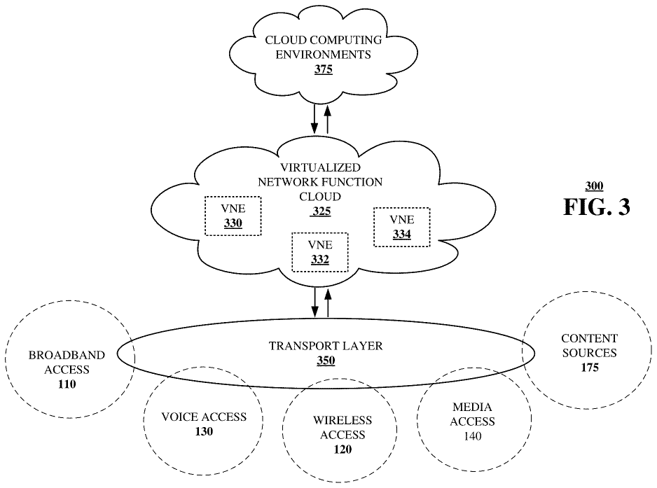

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of the systems shown in FIGS. 1, 2A-2E, and/or some or all of the functions of the methods shown in FIGS. 2F-2H.

For example, virtualized communication network 300 can facilitate in whole or in part vehicle tracking and alerting (such as to facilitate tracking of vehicle movement and transmission of notifications associated with such vehicle movement).

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

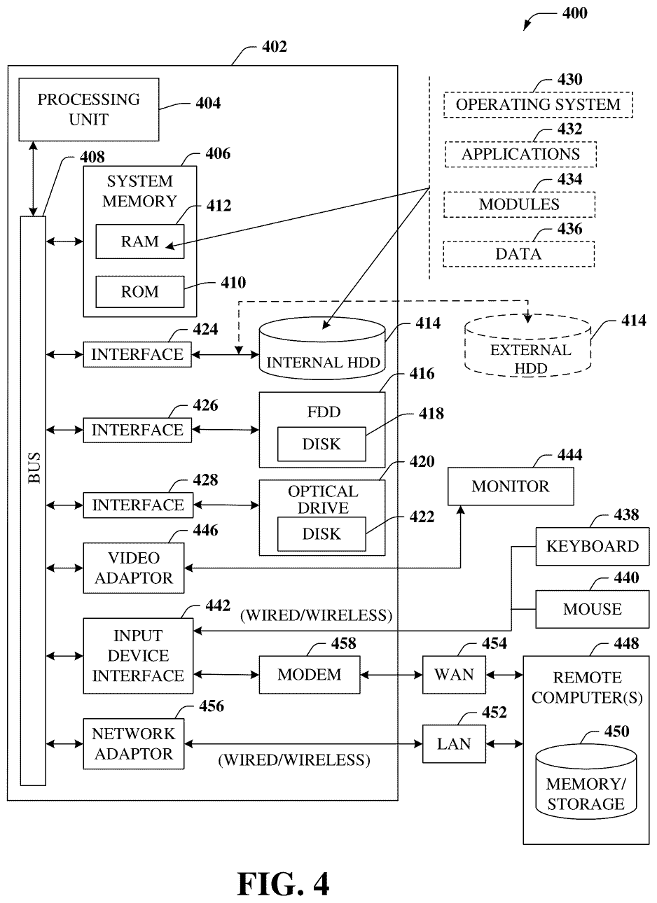

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software.

For example, computing environment 400 can facilitate in whole or in part vehicle tracking and alerting (such as to facilitate tracking of vehicle movement and transmission of notifications associated with such vehicle movement).

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

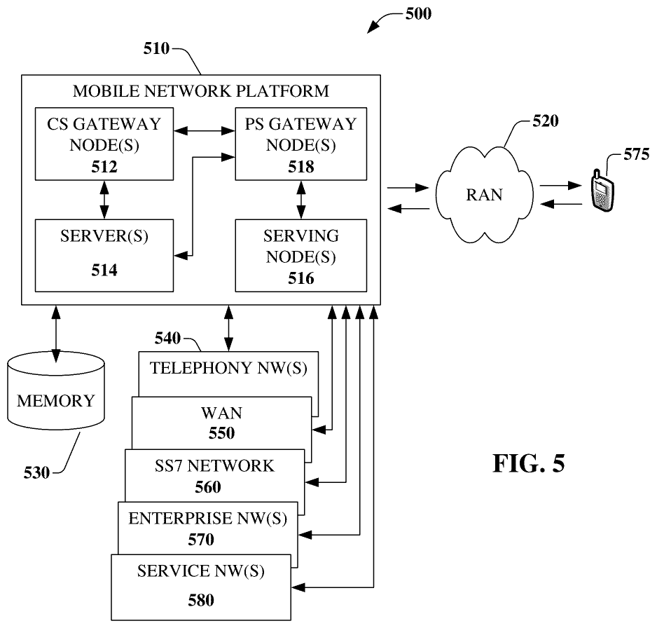

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part vehicle tracking and alerting (such as to facilitate tracking of vehicle movement and transmission of notifications associated with such vehicle movement).

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

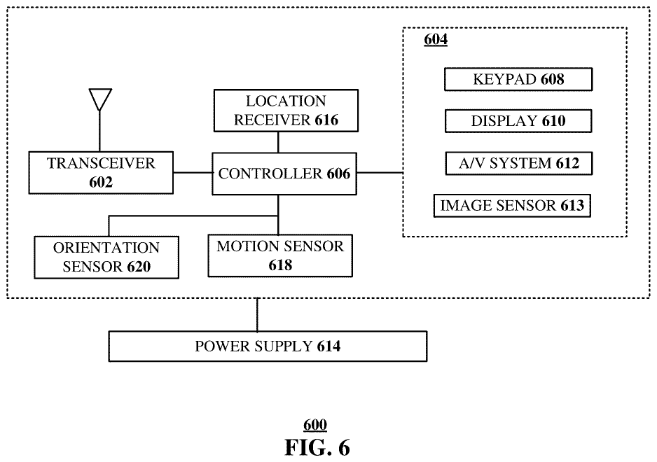

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part vehicle tracking and alerting (such as to facilitate tracking of vehicle movement and transmission of notifications associated with such vehicle movement).

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically tracking vehicle movement and transmitting notifications associated with such vehicle movement) can employ various AI-based schemes for carrying out various embodiments thereof. Moreover, a classifier can be employed to determine a ranking or priority of each vehicle, vehicle movement, and/or driver. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which vehicle(s), vehicle movement(s), and/or driver(s) is to receive priority.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method comprising:
obtaining, by a processing system including a processor, first data associated with a first vehicle, wherein the first data comprises a first location, a first direction of travel, and a first velocity;
obtaining, by the processing system, second data associated with a second vehicle, wherein the second data comprises a second location, a second direction of travel, and a second velocity;
identifying, by the processing system, an alerting condition caused by the second vehicle;
responsive to the identifying of the alerting condition, determining, by the processing system, a relative location vector between the first vehicle and the second vehicle; and
transmitting, by the processing system, a message to the first vehicle, wherein the message includes a description of the alerting condition and the relative location vector.

2. The method of claim 1, wherein:
the relative location vector comprises one of: a distance between the first vehicle and the second vehicle; a relative speed between the first vehicle and the second vehicle;
a relative direction of motion between the first vehicle and the second vehicle; an estimation of a time to collision; or any combination thereof.

3. The method of claim 1, wherein:
the transmitting of the message causes the first vehicle to present information via an on-board display of the first vehicle; and
the information that is presented comprises one of: the description of the alerting condition; the relative location vector; or any combination thereof.

4. The method of claim 3, wherein:
the transmitting of the message causes the first vehicle to present an audible alert that is based upon the relative location vector;
the transmitting of the message causes the first vehicle to present a visual alert that is based upon the relative location vector; or
any combination thereof.

5. The method of claim 1, wherein each of the first location and the second location is defined by a respective: set of latitude/longitude coordinates; street location; physical address; or any combination thereof.

6. The method of claim 1, wherein each of the first data and the second data is obtained: by dynamically determining the respective data in real-time; by receiving the respective data from one of the first vehicle or the second vehicle; or any combination thereof.

7. The method of claim 1, wherein each of the first data and the second data is obtained: from one or more sensors of the first vehicle; from one or more cameras of the first vehicle; from one or more sensors of the second vehicle; from one or more cameras of the second vehicle; from one or more sensors of another vehicle; from one or more cameras of the another vehicle; from one or more external sensors; from one or more external cameras; from one or more traffic signal cameras; from one or more traffic control cameras; or any combination thereof.

8. The method of claim 1, wherein the respective vehicle data is obtained: by being received from each vehicle; by being retrieved from a database; or any combination thereof.

9. The method of claim 1, wherein the alerting condition comprises one of: a driver of the second vehicle being distracted; a driver of the second vehicle being inattentive; a driver of the second vehicle operating under the influence of alcohol; a driver of the second vehicle operating under the influence of drugs; a motion of the second vehicle being erratic; the second vehicle veering out of a lane by more than a threshold amount; the second vehicle failing to stop at a stop sign; the second vehicle failing to stop at a red light; or any combination thereof.

10. The method of claim 9, wherein the alerting condition is identified via image processing analysis of: the driver of the second vehicle; a movement of the second vehicle; or any combination thereof.

11. The method of claim 1, wherein the processing system is part of a wireless network.

12. The method of claim 11, wherein the wireless network comprises a wireless edge network.

13. The method of claim 12, wherein the processing system is part of a node in the wireless edge network.

14. The method of claim 13, wherein the wireless network comprises one of: a fourth generation (4G) cellular network; a fifth generation (5G) cellular network; a subsequent generation cellular network; or any combination thereof.

15. A device comprising:
a processing system including a processor; and
a memory that stores executable instructions that, when executed by the processing system, facilitate performance of operations, the operations comprising:
determining whether a first vehicle is being driven in an unlawful manner, an erratic manner, or any combination thereof, wherein the determining results in a first determination;
responsive to the first determination being that the first vehicle is driven in the unlawful manner, the erratic manner, or any combination thereof, determining whether at least one other vehicle is within a threshold distance of the first vehicle, resulting in a second determination, wherein the at least one other vehicle comprises a second vehicle;
responsive to the second determination being that the at least one other vehicle is within the threshold distance of the first vehicle, obtaining vehicle data associated with the second vehicle, wherein the vehicle data comprises a direction of travel and a velocity; and
responsive to the second determination being that the at least one other vehicle is within the threshold distance of the first vehicle, transmitting a notification to the second vehicle, wherein the notification comprises a relative location vector between the first vehicle and the second vehicle.

16. The device of claim 15, wherein:
the first determination being that the first vehicle is driven in the unlawful manner, the erratic manner, or any combination thereof is made based at least in part upon one of: a first location of the first vehicle; a first velocity of the first vehicle; an improper lane crossing by the first vehicle; a failure of the first vehicle to obey a speed limit, a failure of the first vehicle to stop at a stop sign, a failure of the first vehicle to stop at red light; a failure of the first vehicle to yield; or any combination thereof.

17. The device of claim 15, wherein:
the relative location vector is based at least in part upon one of: locations of the first and second vehicles; travel directions of the first and second vehicles; velocities of the first and second vehicles; or any combination thereof.

18. The device of claim 15, wherein:
the at least one other vehicle further comprises a third vehicle;
responsive to the second determination being that the at least one other vehicle is within the threshold distance of the first vehicle, obtaining additional vehicle data associated with the third vehicle, wherein the additional vehicle data comprises another location, another direction of travel, and another velocity; and
responsive to the second determination being that the at least one other vehicle is within the threshold distance of the first vehicle, transmitting another notification to the third vehicle, wherein the another notification comprises another relative location vector between the first vehicle and the third vehicle.

19. A non-transitory machine-readable medium comprising executable instructions that, when executed by a processing system including a processor, facilitate performance of operations, the operations comprising:
obtaining one or more images of a person driving a first vehicle;
performing image analysis on the one or more images to estimate a level of attentiveness that the person is applying to the driving of the first vehicle;
determining whether the level of attentiveness fails to meet a threshold level of attentiveness, resulting in a first determination;
responsive to the first determination being that the level of attentiveness fails to meet the threshold level of attentiveness, analyzing location data to determine whether a second vehicle is within a threshold distance of the first vehicle, resulting in a second determination;
responsive to the second determination being that the second vehicle is within the threshold distance of the first vehicle, obtaining vehicle data associated with the second vehicle, wherein the vehicle data comprises a location, a direction of travel, and a velocity; and
responsive to the second determination being that the second vehicle is within the threshold distance of the first vehicle, transmitting a notification to the second vehicle, wherein the notification comprises a warning of inattentiveness of the person driving the first vehicle and position data identifying where the first vehicle is relative to the second vehicle.

20. The non-transitory machine-readable medium of claim 19, wherein:
a warning is presented in the second vehicle at a location between a driver of the second vehicle and the first vehicle; and
the warning is one of: an audio warning presented by one or more front-left speakers; an audio warning presented by one or more front-center speakers; an audio warning presented by one or more front-right speakers; an audio warning presented by one or more rear-right speakers; an audio warning presented by one or more rear-center speakers; an audio warning presented by one or more rear-left speakers; a visual warning presented by a forward heads-up display; a visual warning presented by a passenger-side heads-up display; a visual warning presented by a rear heads-up display; a visual warning presented by a driver-side heads-up display; or any combination thereof.
